(19) United States
(12) Patent Application Publication
(10) Pub. No.: US 2016/0092893 A1
(43) Pub. Date: Mar. 31, 2016

(54) SYSTEM, METHOD, AND APPARATUS FOR PREDICTING ITEM CHARACTERISTIC POPULARITY

(71) Applicant: eBay Inc., San Jose, CA (US)

(72) Inventors: Hugo Liu, New York, NY (US); Elizabeth Churchill, San Francisco, CA (US)

(21) Appl. No.: 14/563,828

(22) Filed: Dec. 8, 2014

Related U.S. Application Data
(63) Continuation of application No. 62/057,148, filed on Sep. 29, 2014.

(51) Int. Cl. G06Q 30/02; G06F 17/30

(52) U.S. Cl. CPC G06Q 30/0202; G06F 17/30867

(57) ABSTRACT

The present disclosure is directed to apparatuses, systems, and methods for predicting item characteristic popularity—i.e., identifying item characteristics (e.g., item brands, item types, etc.) that are to eventually become popular. Something that is to eventually become popular is referred to herein as “pre-trend” or “cool.” In the embodiments described herein, electronic marketplace transaction data is analyzed to identify popular characteristics of items involved in recent transactions. The electronic marketplace transaction data is further analyzed to identify one or more users that executed transactions for items having these popular characteristics during a previous time period. These users' transaction histories are analyzed to determine what other item characteristics are prevalent in their more recent transactions, as these item characteristics can be identified as pre-trend/cool.

### CLAIM OF PRIORITY

This application claims the benefit of priority to U.S. Provisional Patent Application Ser. No. 62/057,148, filed on Sep. 29, 2014, which is incorporated by reference herein in its entirety.

### TECHNICAL FIELD

The present application relates generally to the technical field of data processing and, in particular, to providing a process for predicting item characteristic popularity.

### BACKGROUND

When a user visits a publication system such as a network-based marketplace, some item listings are often displayed as recommendations to the user. Recommended item listings are selected based on their similarity to other items in the user's transaction history, or merely identify products involved in a high number of marketplace transactions. These types of recommendations are limited and not suitable for taste-sensitive domains, such as fashion.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 illustrates a network architecture of an exemplary system according to aspects of the disclosure.

FIG. 2 illustrates exemplary applications executable by one or more application servers according to aspects of the disclosure.

FIG. 3 illustrates an exemplary client machine according to aspects of the disclosure.

FIG. 4 is a block diagram illustrating components of a machine, according to some example embodiments, able to read instructions from a machine-readable medium and perform any one or more of the methodologies discussed herein, according to aspects of the disclosure.

FIG. 5 illustrates a webpage of a publication system (e.g., an electronic marketplace) configured to publish item listings according to aspects of the disclosure.

FIG. 6 is a flow diagram of a process for identifying users and item characteristics of interest according to an embodiment.

FIG. 7 illustrates a process for identifying at least one popular item characteristic from electronic marketplace data according to an embodiment.

FIG. 8 illustrates a process for identifying pre-trend/cool users from electronic marketplace data according to an embodiment.

FIG. 9 is a graphical user interface for generating item characteristic recommendations for a user according to an embodiment.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art, that embodiments of the inventive subject matter can practiced without these specific details. In general, well-known instruction instances, protocols, structures, and techniques have not been shown in detail.

The present description is directed to apparatuses, systems, and methods for predicting item characteristic popularity—i.e., identifying item characteristics (e.g., item brands, item types, etc.) that are to eventually become popular. Something that is to eventually become popular is referred to herein as “pre-trend” or “cool” (other similar terms may alternatively be used, such as emerging, early, proliferating, escalating, on the rise, etc.—any term to describe a characteristic at a stage before it becomes on-trend). In the embodiments described herein, electronic marketplace transaction data is analyzed to identify popular characteristics of items involved in recent transactions. The electronic marketplace transaction data can be further analyzed to identify one or more users that executed transactions for items having these popular characteristics during a previous time period. These users' transaction histories are analyzed to determine what other item characteristics are prevalent in their more recent transactions, as these item characteristics can be identified as pre-trend/cool.

In other words, marketplace users who have repeatedly purchased items having characteristics (e.g., brands, item colors, item types, etc.) that eventually became popular are presumed to have foresight into what is to eventually become popular. By identifying these users, pre-trend/cool item characteristics (i.e., characteristics that are to become increasingly popular) can be determined via various machine-learning algorithms. Identifying future pre-trend/cool item characteristics helps electronic marketplaces identify pre-trend/cool item characteristics relevant to specific customers, and helps the marketplaces and specific vendors improve products and product inventory based on forecasted pre-trend/cool item characteristics.

The methods or embodiments disclosed herein can be implemented as a computer system having one or more modules (e.g., hardware modules or software modules). Such modules can be executed by one or more processors of the computer system. The methods or embodiments disclosed herein can be embodied as instructions stored on a machine-readable medium that, when executed by one or more processors, cause the one or more processors to execute the instructions.

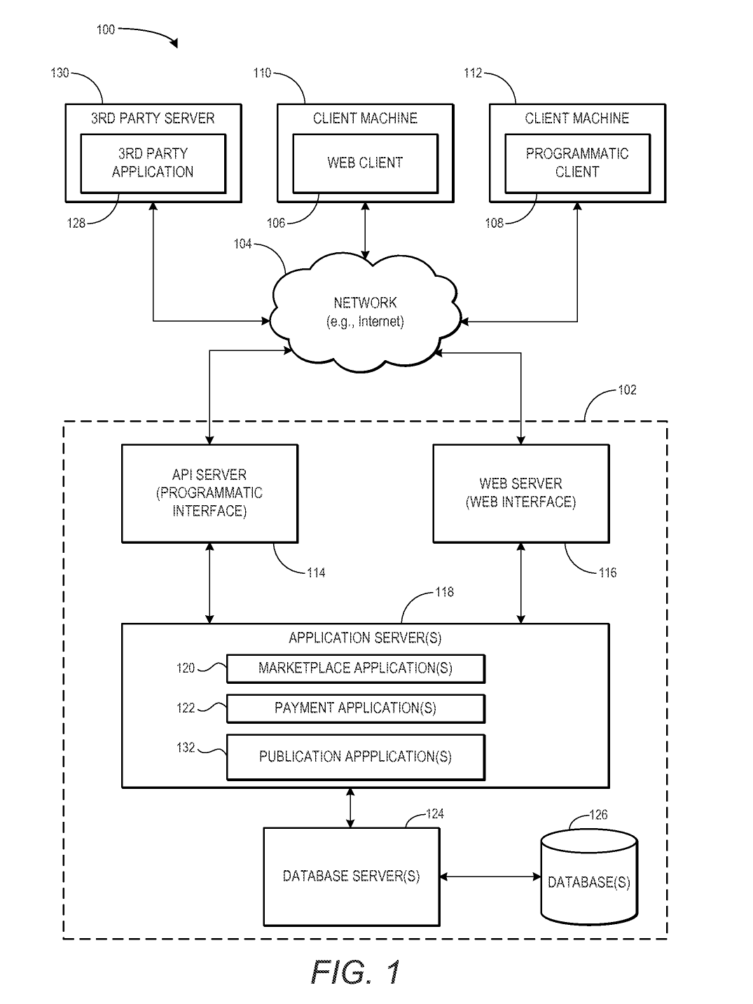

FIG. 1 is a network diagram depicting a client-server system 100 according to aspects of the disclosure. A networked system 102, in the example forms of a network-based marketplace or publication system (e.g., a Comparison Shopping Engine (CSE)), provides server-side functionality, via a network 104 (e.g., the Internet or a Wide Area Network (WAN)), to one or more client machines. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An Application Programming Interface (API) server 114 and a web server 116 provide presentation layers and are coupled to, and provide programmatic and web interfaces respectively to, one or more application servers 118. The application server(s) 118 host one or more applications, such as a marketplace application(s) 120, a payment application(s) 122, and one or more publication applications 132. The application server(s) 118 are, in turn, shown to be coupled to one or more database servers 124 that facilitate access to one or more databases 126.

The marketplace application(s) 120 can provide a number of marketplace functions and services to users who access the networked system 102. The payment application(s) 122 may likewise provide a number of payment services and functions to users. The payment application(s) 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace application(s) 120.

As discussed further below, price ranges and price points can be collected from one or more sources, such as items being offered for sale through an electronic marketplace, items being offered at auctions hosted by the electronic marketplace, items having been previously sold through the electronic marketplace, external sources (e.g., APIs to other electronic marketplaces), and other such sources. Thus, when a search query is received for items being offered for sale through the electronic marketplace, the application server(s) 118 may provide one or more price ranges for the prices of search results that correspond to the received search query.

In one embodiment, the databases 126 are storage devices that store information to be posted (e.g., publications or listings) via the publication application(s) 132. The database(s) 126 may also store digital goods information in accordance with example embodiments. 1

In example embodiments, the publication application(s) 132 publishes content on a network (e.g., the Internet). As such, the publication application(s) 132 provides a number of publication and marketplace functions and services to users who access the networked system 102. In example embodiments, the publication application(s) 132 is discussed in terms of an online marketplace environment. However, it is noted that the publication application(s) 132 can be associated with a non-marketplace environment such as an informational (e.g., search engine), a social-networking environment, a business to business (B2B) trading portal, a virtual community, etc.

While the marketplace application(s) 120, the payment application(s) 122, and the publication application(s) 132 are shown in FIG. 1 to form part of the networked system 102, it will be appreciated that, in alternative embodiments, the applications 120, 122, and 132 can be separate and distinct from the networked system 102. For example, the payment application(s) 122 may form part of a payment service that is separate and distinct from the networked system 102.

Further, while the system 100 shown in FIG. 1 employs a client-server architecture, the embodiments are of course not limited to such an architecture, and could equally well find application in a distributed, or peer-to-peer, architecture system, for example. The marketplace application(s) 120, the payment application(s) 122, and the publication application(s) 132 could also be implemented as standalone software programs, which do not necessarily have networking capabilities.

The web client 106 may access the marketplace application(s) 120, the payment application(s) 122, and the publication application(s) 132 via the web interface supported by the web server 116. Similarly, the programmatic client 108 may access the various services and functions provided by the applications 120, 122, and 132 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, payment, or advertising functions that are supported by the relevant applications of the networked system 102.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services.

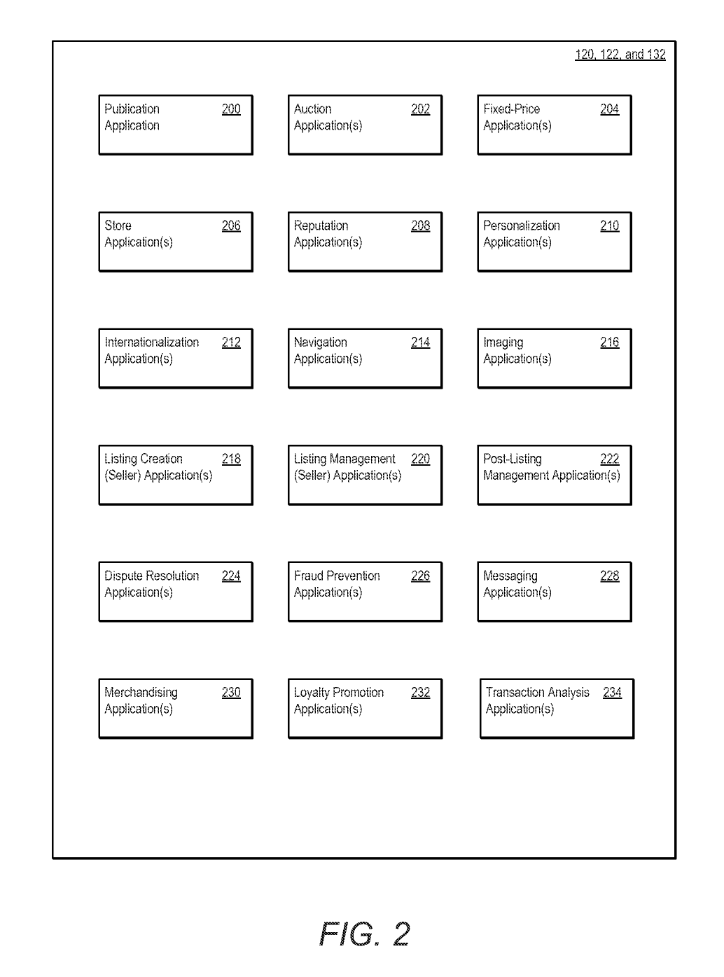

FIG. 2 illustrates exemplary applications that can be executable by the foregoing application server(s) 118 to support the aforementioned mechanisms. To this end, the marketplace application(s) 120, the payment application(s) 122 are shown to include at least one publication application 200 (including at least publication application(s) 112 and one or more auction applications 202, which support auction-format listing and price setting mechanisms (e.g., English, Dutch, Vickrey, Chinese, Double, and Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement type listing or a catalogue listing) and buyout-type listings. Specifically, buyout-type listings (e.g., including the Buy-It-Now (BIN) technology developed by eBay Inc., of San Jose, Calif.) can be offered in conjunction with auction-format listings, and allow a buyer to purchase goods or services, which are also being offered for sale via an auction, for a fixed price that is typically higher than the starting price of the auction.

Store applications 206 allow a seller to group listings within a “virtual” store, which can be branded and otherwise personalized by and for the setter. Such a virtual store may also offer promotions, incentives, and features that are specific and personalized to a relevant seller.

Reputation applications 208 allow users who transact, utilizing the networked system 102, to establish, build, and maintain reputations, which can be made available and published to potential trading partners. Consider that where, for example, the networked system 102 supports person-to-person trading, users may otherwise have no history or other reference information whereby the trustworthiness and credibility of potential trading partners can be assessed. The reputation applications 208 allow a user (e.g., through feedback provided by other transaction partners) to establish a reputation within the networked system 102 over time. Other potential trading partners can then reference such a reputation for the purposes of assessing credibility and trustworthiness.

Personalization applications 210 allow users of the networked system 102 to personalize various aspects of their interactions with the networked system 102. For example a user may, utilizing one of the appropriate personalization applications 210, create a personalized reference page on which information regarding transactions to which the user is (or has been) a party can be viewed. Further, one of the personalization applications 210 can enable a user to personalize listings and other aspects of their interactions with the networked system 102 and other parties.

The networked system 102 can support a number of marketplaces that are customized, for example, for specific geographic regions. A version of the networked system 102 can be customized for the United Kingdom, whereas another version of the networked system 102 can be customized for the United States. Each of these versions can operate as an independent marketplace or can be customized (or internationalized) presentations of a common underlying marketplace. The networked system 102 may, accordingly, include a number of internationalization applications 212 that customize information in (and/or the presentation of information by) the networked system 102 according to predetermined criteria (e.g., geographic, demographic, or marketplace criteria). For example, the internationalization applications 212 can be used to support the customization of information for a number of regional websites that are operated by the networked system 102 and that are accessible via the web server 116.

Navigation of the networked system 102 can be facilitated by one or more navigation applications 214. For example, a search application (as an example of one of the navigation applications 214) can enable key word searches of listings published via the networked system 102. A browsing application can allow users to browse various category, catalogue, or inventory data structures according to which listings can be classified within the networked system 102. Various others of the navigation applications 214 can be provided to supplement the search and browsing applications.

In order to make the listings available via the networked system 102 as visually informative and attractive as possible, the applications 120 and 122 can include one or more imaging applications 216, which users can utilize to upload images for inclusion within listings. The imaging applications 216 also operate to incorporate images within viewed listings. The imaging applications 216 can also support one or more promotional features, such as image galleries that are presented to potential buyers. For example, sellers can pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings can present a challenge. The listing management applications 220 provide a number of features (e,g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller can wish to leave feedback regarding a particular buyer. To this end, one or more post-listing management applications 222 can provide an interface to one or more reputation applications 208, on as to allow the seller conveniently to provide feedback regarding multiple buyers to the reputation applications 208.

Dispute resolution applications 224 provide mechanisms whereby disputes arising between transacting parties can be resolved. For example, the dispute resolution applications 224 can provide guided procedures whereby the parties are guided through a number of steps in an attempt to settle a dispute. In the event that the dispute cannot be settled via the guided procedures, the dispute can be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such as, for example, messages advising users regarding the status of listings at the networked system 102 (e.g., providing “outbid” notices to bidders during an auction process or providing promotional and merchandising information to users). Respective messaging applications 228 can utilize any one of a number of message delivery networks and platforms to deliver messages to users. For example, the messaging applications 228 can deliver electronic (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WIMAX) networks.

Merchandising applications 230 support various merchandising functions that are made available to sellers to enable sellers to increase sales via the networked system 102. The merchandising applications 230 also operate the various merchandising features that can be invoked by sellers, and can monitor and track the success of merchandising strategies employed by sellers.

The networked system 102 itself, or one or more parties that transact via the networked system 102, can operate loyalty programs that are supported by one or more loyalty/promotions applications 232. For example, a buyer can earn loyally or promotion points for each transaction established and/or concluded with a particular seller, and can be offered a reward for which accumulated loyalty points can be redeemed.

One or more transaction analysis application(s) 234 are used, in part, for the processes described below to identify pre-trend/cool item characteristics (e.g., item brands, item types, etc.). Electronic marketplace transaction data is analyzed by the transaction analysis application(s) 234 to identify popular characteristics of items involved in recent transactions. The electronic marketplace transaction data is further analyzed by the transaction analysis application(s) 234 to identify one or more users that executed transactions for items having these popular characteristics during a previous time period. These users' transaction histories are analyzed by the transaction analysis application(s) 234 to determine what other item characteristics are prevalent in their more recent transactions, as these item characteristics are identified as pre-trend/coot.

As the publication application(s) 132 can be integrated (e.g., directly or indirectly) with the application server(s) 118, the publication application(s) 132 can leverage the data obtained from the applications 200-232 and provide relatively up-to-date or current listings for items being offered through the electronic marketplace. This integration can further extend to the one or more database server(s) 124 and/or database(s) 126 in communication with the application server(s) 118.

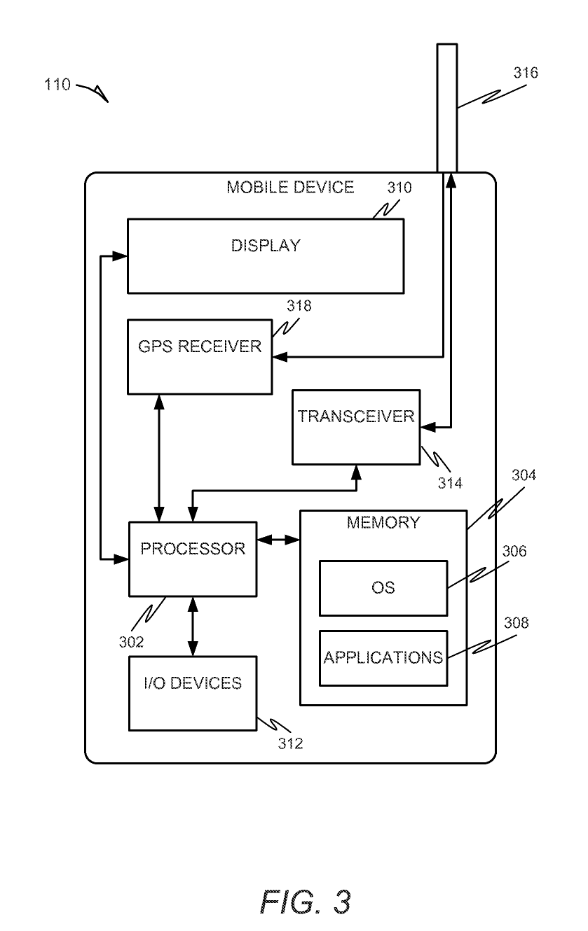

FIG. 3 illustrates one example for one of the client machines—client machine 110—in accordance with aspects of the disclosure. In one embodiment, the client machine 110 can be a mobile device. The mobile device can include a processor 302. The processor 302 can be any of a variety of different types of commercially available processors suitable for mobile devices (e.g., an ARM architecture microprocessor, a Microprocessor without Interlocked Pipeline Stages (MIPS) architecture processor, or another type of processor). A memory 304, such as a random access memory (RAM), a Flash memory, or another type of memory, is typically accessible to the processor 302. The memory 304 can be adapted to store an operating system (OS) 306, as well as applications 308, such as a mobile location enabled application that can provide location-based services to a user. The processor 302 can be coupled, either directly or via appropriate intermediary hardware, to a display 310 and to one or more input/output (I/O) devices 312, such as a keypad, a touch panel sensor, a microphone, and the like. In some embodiments, the display 310 comprises a touchscreen display capable of functioning as an I/O device. Similarly, in some embodiments, the processor 302 can be coupled to a transceiver 314 that interfaces with an antenna 316. The transceiver 314 can be configured to both transmit and receive cellular network signals, wireless data signals, or other types of signals via the antenna 316, depending on the nature of the client machine 110. Further, in sonic configurations, a GPS receiver 318 can also make use of the antenna 316 to receive GPS signals.

The applications 308 of the client machine 110 (e.g., a mobile device) can further include one or more browser applications, such as mobile browser applications, which can be used to provide a user interface to permit the user to browse information available over a network interface. The applications 308 can further include one or more provider-specific mobile applications (alternatively referred to herein as “mobile apps”), downloaded (e.g., downloaded by the user from a mobile software distribution platform) and resident on the client machine 110, that enable the user to access content through the mobile app in addition to said mobile browser application.

As referred to herein, mobile browsers and mobile apps can describe computer programs designed to run specifically on mobile devices such as smartphones, tablet computers, other handheld computing devices, etc. Mobile browsers and mobile apps can be designed with consideration of the constraints (e.g., low-power processors, limited memory, etc.) and features (e.g., location identification capabilities using geo-location sensors, integrated cellular telephone connectivity, etc.) of mobile devices. Mobile browsers and mobile apps can also implement mobile user interface (UI) designs that consider constraints of the screen size of the display 310, touchscreen capabilities of the display 310, etc.

Certain embodiments are described herein as including logic or a number of components, modules, or mechanisms. Modules can constitute either software modules (e.g., code embodied on a machine-readable medium or in a transmission signal) or hardware modules. A hardware module is a tangible unit capable of performing certain operations and can be configured or arranged in a certain manner. In example embodiments, one or more computer systems (e.g., a standalone, client, or server computer system or one or more hardware modules of a computer system (e.g., a processor or a group of processors) can be configured by software (e.g., an application or application portion) as a hardware module that operates to perform certain operations as described herein.

In various embodiments, a hardware module can be implemented mechanically or electronically. For example, a hardware module can comprise dedicated circuitry or logic that is permanently configured (e.g., as a special-purpose processor, such as a field programmable gate array (FPGA) or an application-specific integrated circuit (ASIC)) to perform certain operations. A hardware module can also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e,g., configured by software) can be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor can be configured as respective different hardware modules at different times. Software can accordingly configure a processor, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple of such hardware modules exist contemporaneously, communications can be achieved through signal transmission (e.g., over appropriate circuits and buses that connect the hardware modules). In embodiments in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions. The modules referred to herein may, in some example embodiments, comprise processor-implemented modules.

Similarly, the methods described herein can be at least partially processor-implemented. For example, at least some of the operations of a method can be performed by one or more processors or processor-implemented modules. The performance of certain of the operations can be distributed among the one or more processors, not only residing within a single machine, but deployed across a number of machines. In some example embodiments, the processor or processors can be located in a single location (e.g., within a home environment, an office environment, or a server farm), while in other embodiments the processors can be distributed across a number of locations.

The one or more processors can also operate to support performance of the relevant operations in a “cloud computing” environment or as a “software as a service” (SaaS). For example, at least some of the operations can be performed by a group of computers (as examples of machines including processors), these operations being accessible via a network (e.g., the network 104 of FIG. 1) and via one or more appropriate interfaces (e.g., APIs).

Example embodiments can be implemented in digital electronic circuitry, or in computer hardware, firmware, or software, or in combinations of them. Example embodiments can be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations can be performed by one or more programmable processors executing a computer program to perform functions by operating on input data and generating output. Method operations can also be performed by, and apparatus of example embodiments can be implemented as, special purpose logic circuitry (e.g., an FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware can be a design choice. Below are set out hardware (e.g., machine) and software architectures that can be deployed, in various example embodiments. It is contemplated that any features of any embodiments disclosed herein can be combined with any other features of any other embodiments disclosed herein. Accordingly, any such hybrid embodiments are within the scope of the present disclosure.

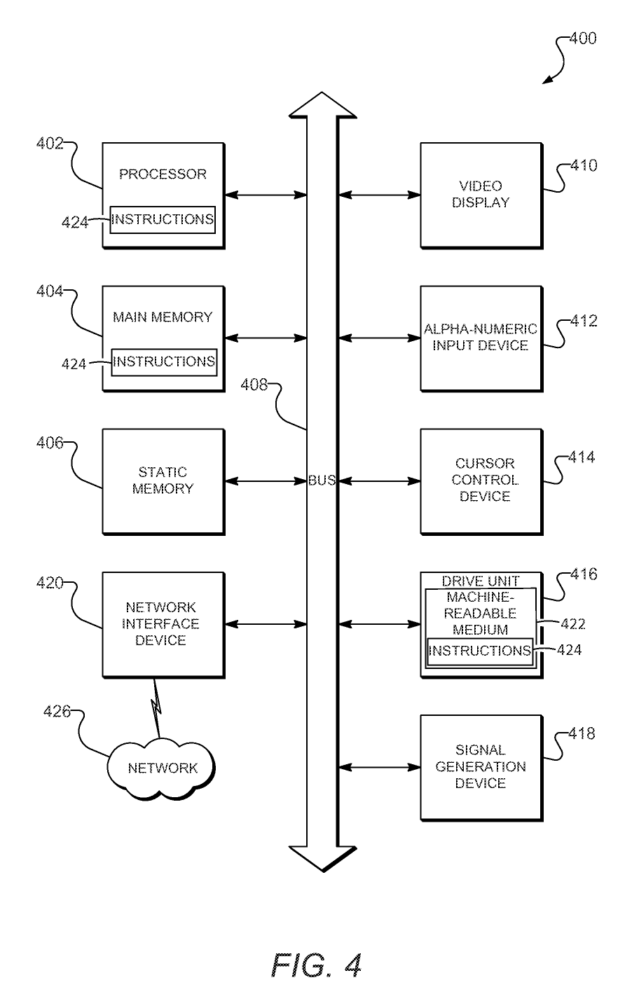

FIG. 4 is a block diagram illustrating components of a machine, according to some example embodiments, able to read instructions from a machine-readable medium and perform any one or more of the methodologies discussed herein, according to aspects of the disclosure. In particular, FIG. 4 illustrates an exemplary computer system 400 within which instructions 424 for causing the machine to perform any one or more of the methodologies discussed herein can be executed. In alternative embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (CPU), or both), a main memory 404, and a static memory 406, which communicate with each other via a bus 408. The computer system 400 can further include a video display 410 (e.g., a liquid crystal display (LCD) or a cathode ray tube (CRT). The computer system 400 also includes an alphanumeric input device 412 (e.g., a keyboard), a UI navigation (or cursor control) device 414 (e,g., a mouse), a disk drive unit 416, a signal generation device 418 (e.g., a speaker) and a network interface device 420.

The disk drive unit 416 includes a non-transitory machine-readable medium 422 on which is stored one or more sets of data structures and instructions 424 (e.g., software) embodying or utilized by any one or more of the methodologies or functions described herein. The instructions 424 can also reside, completely or at least partially, within the main memory 404 and/or within the processor 402 during execution thereof by the computer system 400, the main memory 404 and the processor 402 also constituting non-transitory, machine-readable media. The instructions 424 can alternatively reside, completely or at least partially, within the static memory 406.

While the non-transitory machine-readable medium 422 is shown in an example embodiment to be a single medium, the term “machine-readable medium” can include a single medium or multiple media (e.g., a centralized or distributed database, and/or associated caches and servers) that store the one or more data structures and instructions 424. The term “machine-readable medium” shall also be taken to include any tangible medium that is capable of storing, encoding, or carrying instructions for execution by the machine and that cause the machine to perform any one or more of the methodologies of the present embodiments, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disk-read-only memory (CD-ROM) and digital versatile disk (or digital video disk) read-only memory (DVD-ROM) disks.

The instructions 424 can further be transmitted or received over a communications network 426 using a transmission medium. The instructions 424 can be transmitted using the network interface device 420 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

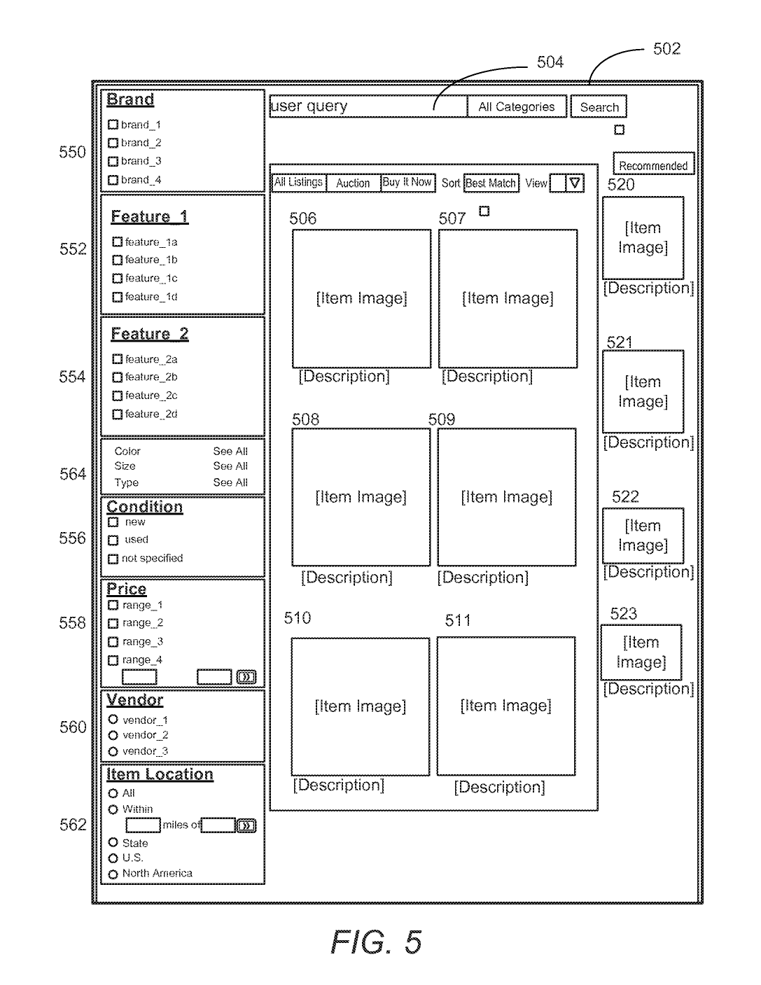

FIG. 5 illustrates a webpage 502 of a publication system (e.g., an electronic marketplace) configured to publish item listings according to aspects of the disclosure. The webpage 502 can include an element, such as a text entry box 504, where the user can provide a search query to search for listings offered by the marketplace. The webpage 502 and subsequent exemplary web pages illustrated and described below can alternatively comprise mobile browser or mobile app implementations in other embodiments.

The displayed search results can include listings 506-511 that are selected (from a larger set of listings, some of which can be displayed on subsequent pages) to be displayed based, at least in part, on the listings' relevance to the search query entered into the text entry box 504. Each of the listings 506-511 is shown to include an item image and an item description; each of the item descriptions can include a title, price, brand identification, etc.

In this embodiment, a plurality of filters 550-564 and corresponding filter values are displayed; these filters 550-564 are selectable for narrowing the scope of displayed search results for the search query entered into the text entry box 504. The filters 550-564 are shown in this example to include a brand filter 550, item feature filters 552 and 554 (labeled generically in this figure as “Feature_1” and “Featur_2”), an item condition filter 556, a price filter 558, a vendor filter 560, and an item location filter 562. The price filter 558 and the item location filter 562 are shown to accept manual user input to configure the filter 558, 562. In addition, an expandable filter set 564 is displayed to allow the user to further narrow the scope of displayed search results for the search query.

In this embodiment, listings 520-523 comprise a second set of listings that are selected for display according to a different metric than that used to select the listings 506-511. As shown in this illustration, listings 520-523 comprise “recommended” listings for the user. Using prior art processes, the listings 520-523 can be selected based, at least in part, on popularity (i.e., different user views) in addition to relevance to the search query entered into the text entry box 504.

Users can identify trending or currently popular brands as irrelevant or stale; users can want to identify what is to become trending or popular in the future. Thus, when selecting item listings to be displayed as recommendations to the user (such as item listings 520-523), identifying popular item characteristics alone can not generate meaningful recommendations for the user. In other words, identifying rending items characteristics is not analogous to identifying “pre-trend” item brands.

As described in further detail below, embodiments identify future pre-trend/cool item characteristics to help electronic marketplaces identify pre-trend/cool item characteristics relevant to specific customers, in addition to helping the marketplaces and specific vendors improve products and product inventory based on forecasted pre-trend/cool item characteristics. For example, when the user search query entered in text entry box 504 has been further limited via the brand filter 550 (e.g., when any of “brand_1”-“brand_4” is selected), embodiments can identify and recommend trendier/cooler brands to the user; these recommended brands can be for product types related or unrelated to the search query i.e., the recommended brands can be across different item categories, such as clothing brands, accessory brands, electronic brands, etc. For example, a user can be recommended shoe brands (or, in some embodiments, brands for significantly less related items, such as houseware or electronic device brands) in response to a user's interest in one or more clothing brands. In sonic embodiments, the identification of pre-trend/cool brands can also be used when selecting the search results including listings 506-511 for display.

Thus, pre-trendiness/coolness can be extracted via a machine executed process into a tangible metric that is assignable to items, item characteristics, and users; this metric can therefore be used to enhance search results and recommendations generated fur marketplace users, as well as for generating analytical data for vendors and marketplace publishers.

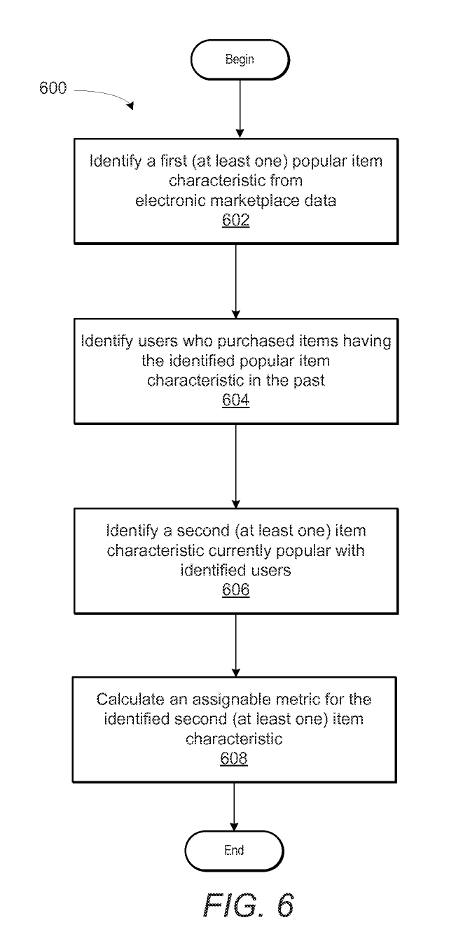

FIG. 6 is a flow diagram of a process for identifying users and item characteristics of interest according to an embodiment. Logical flow diagrams as illustrated herein provide examples of sequences of various process actions. Although shown in a particular sequence or order, unless otherwise specified, the order of the actions can be modified. Thus, the described and illustrated implementations should be understood only as examples, and the illustrated processes can be performed in a different order, and some actions can be performed parallel. Additionally, one or more actions can be omitted in various embodiments; thus, not all actions are required in every implementation. Other process flows are possible.

Logic flow 600 is shown to include identifying at least one popular item characteristic from electronic marketplace data (block 602). The identified popular item characteristic can be an item brand, an item type (e,g., clothing article type, electronic device type, etc.), or any other identifiable item characteristic (e.g., color, shape, etc.).

To identify a (currently) popular item characteristic is to identify a materialized trend. Some users are predisposed to identify (i.e., predict) trends before they materialize. These users can thus be classified as pre-trend/cool. Item characteristics, such as brands, are identified by users as pre-trend/coot when they are strongly associated with pre-trend/cool individuals, and less so when they are strongly associated with others. Pre-trend/cool users are identified, in part, by analyzing transaction data to identify users who purchased items having the popular item characteristic during a previous time interval (block 604). In other words, a subset of transactions are identified as prescient because they involved said item characteristic at the very outset of its respective trend. As described in further detail below, additional operations can be executed for identifying pre-trend/cool users,

Users connected to prescient transactions can be assigned a pre-trendiness/coolness metric, wherein their likeliness to be associated with future trends comprises an assignable value. Once users having a sufficiently high pre-trendiness/coolness metric are identified, then a second (at least one) item characteristic is identified that is popular within the identified pre-trend/cool users (block 606). The prevalence of this identified item characteristic can be measured within the identified pre-trend/cool users and the remaining marketplace users to determine an assignable metric value of the item characteristic (block 608). Thus, items characteristics can further be assigned metrics related to their pre-trendiness/coolness. For example, a Bayesian classifier, akin to those frequently used in email spam filters, can be used to produce a list of all fashion brands, rank ordered by a “cool” statistic. Naive Bayes classifiers correlate the use of tokens (typically words), with certain categories (in these embodiments, pre-trend/cool vs. not pre-trend/not cool) and then Bayesian inference is used to calculate a probability that something is or is not pre-trend/cool. Other embodiments can use other processes for determining said assignable pre-trend/cool metric value.

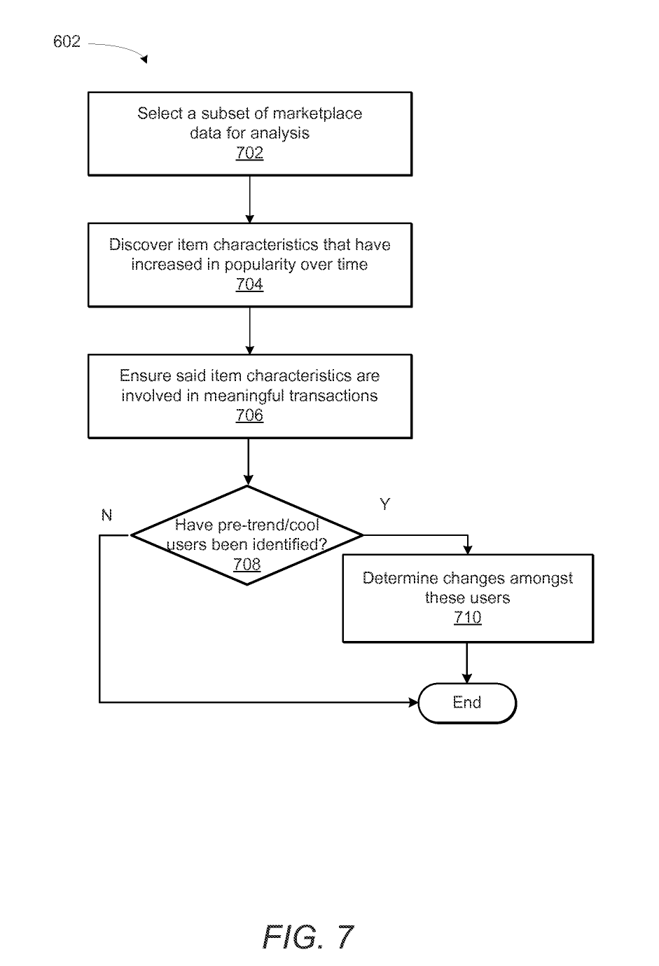

FIG. 7 illustrates a process for identifying at least one popular item characteristic from electronic marketplace data (block 602 from FIG. 6). A subset of the available electronic marketplace data is selected for analysis (block 702). Electronic marketplace data can be limited by active or passive user data. For example, referring back to FIG. 5, search queries actively limited by the user via the selection of one or more of the filters 550-564 can also be used to limit the electronic marketplace data that is to be analyzed. Furthermore, user profile data can be used to passively (i.e., without direct user input) limit the electronic marketplace data that is to be analyzed.

In this embodiment, marketplace data is analyzed to discover item characteristics that have been involved in an increasing quantity over a given time period (block 704). For example, the number of marketplace transactions associated with emerging clothing brands can increase over a period of two or more years before they can be considered a materialized trend. Said increase is typically consistent with an exponential curve, but embodiments can identify linear increases, logarithmic increases, etc. In this embodiment, in addition to increased marketplace transactions, increased transaction revenue is also identified to ensure that a particular item characteristic is involved in meaningful transactions (block 706),

If pre-trend/cool users have been identified (e.g., users identified from the execution of block 604 of FIG. 6) (block 708), an operation is executed to determine changes for the identified item characteristic in marketplace transactions associated with the identified pre-trend/cool users from block 604 (block 710); otherwise the process ends. This analysis can be used to determine, for example, a brand's “health” i.e.,—whether pre-trend/cool customers are abandoning a brand's products, and thus projecting a future market loss. In other embodiments, this operation to determine a brand's “health” can be executed independently from the illustrated process. The described “brand” health report can comprise an automatically generated periodic report, and can not necessarily be generated based on any changes in transaction quantity or revenue. For example, a brand can be steadily popular with pre-trend/cool users, thereby exhibiting no discernable increase in marketplace transactions and/or revenue; thus, a steady percentage of transactions within a changing pre-trend/coot user group can be a positive sign for the brand.

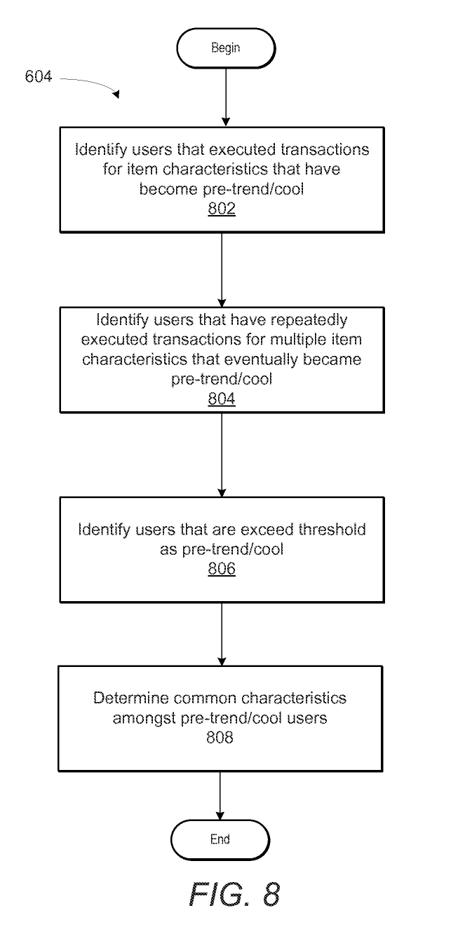

FIG. 8 illustrates a process for identifying pre-trend/cool users from electronic marketplace data (block 604 from FIG. 6). Users are identified that executed marketplace transactions associated with the pre-trend/cool item characteristics during a previous time interval (block 802). For example, if a trend is considered to take two years to materialize, then marketplace transactions 18-24 months old can be analyzed to identify said users.

In some embodiments, marketplace data is farther analyzed to determine if the users identified in block 802 have repeatedly executed marketplace transactions associated with other pre-trend/cool item characteristics (block 804). In other words, a hindcasting process is executed to determine if tracking a user's previous marketplace transactions would have predicted known trends above a certain threshold quantity or percentage (e.g., more than half the user's brands of choice eventually became trends). Any users that exceed said threshold quantity or percentage of said transactions can be identified as pre-trend/cool users (block 806), and are used to execute the other operations discussed above.

The data related to the identified pre-trend/cool users can be further analyzed to determine common characteristics amongst these users (block 808). For example, the geographic location, occupation, age, etc. of these users can be identified to further associate how these users can be viewed within certain demographics. Furthermore, data related to the identified pre-trend/cool users can be used to determine geographic locations where trends often emerge, age groups that are likely to start trends, etc. (This data can also be used to conversely determine geographic locations where trends often do not emerge, age groups that are likely to extinguish trends, etc.)

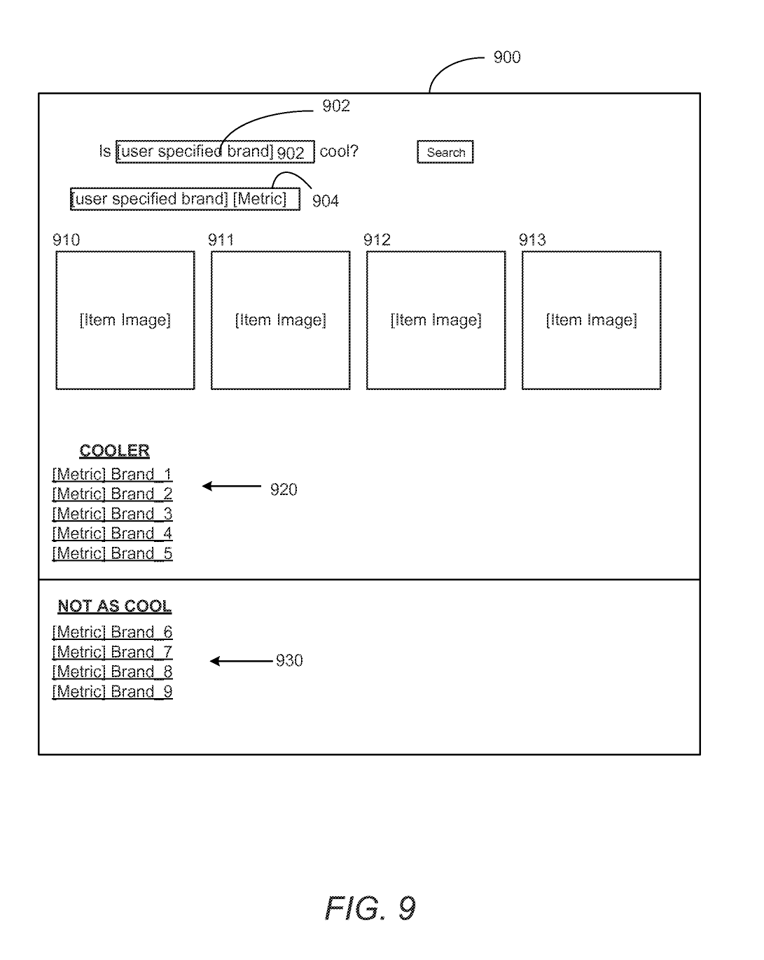

FIG. 9 is a GUI for generating item characteristic recommendations for a user according to an embodiment. A GUI 900 is illustrated as a webpage, but can also comprise a mobile app, etc., in other embodiments. GUI 900 includes a text entry box 902, where the user can enter the name of a brand (or any item characteristic, as described above). In this embodiment, a pre-trendiness/coolness metric (e.g., an assignable numeric value) 904 is displayed, along with various items 910-913 which are offered by the brand manufacturer. As described above, the value 904 can be based on how trend/cool the brand is within identified pre-trend/cool users of an electronic marketplace.

Results 920 are illustrated as brands that are each associated with a pre-trendiness/coolness value higher than that of value 904, and results 930 are illustrated as brands that are each associated with a pre-trendiness/coolness value lower than that of value 904. In this embodiment, the user can select any of displayed items 910-913 to further limit the displayed results (e.g., a selection of item 910 can narrow results 920 and 930 to those brands that also provide said item). Other embodiments can utilize the described pre-trendiness/coolness metrics to generate other results (e.g., to track a user's current and historical pre-trendiness/coolness).

While this example illustrates a user actively identifying a brand, other embodiments can generate similar results based on other user input. For example, a user can answer a series of questions such that results 920 and 930 are generated to display brands that the user is likely to find pre-trend/cool. In another example, user profile data is brands that the user is likely to find pre-trend/cool. As discussed above, this type of user input or data can be used to limit the electronic marketplace data that is analyzed to identify pre-trend/cool users and item characteristics. Furthermore, in other embodiments, passive notifications to a user (e.g., periodic emails) can be sent that convey similar information—i.e., identifying brands of items the user is currently purchasing and recommending other brands across multiple item categories.

Although an embodiment has been described with reference to specific example embodiments, it will be evident that various modifications and changes can be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A non-transitory machine-useable storage medium embodying instructions which, when executed by a machine, cause the machine to execute operations comprising:
receiving a query for one or more item listings of an electronic marketplace database;
identifying data representing a first set of one or more popular item characteristics from electronic marketplace transaction data;
identifying one or more users, from the electronic marketplace transaction data, associated with marketplace transactions for items having the first set of identified popular item characteristics during a first time interval;
identifying data representing a second set of one or more pre-trend item characteristics, from the electronic marketplace transaction data, associated with marketplace transactions of the identified users during a second time interval more recent than the first time interval; and
generating display data representing a query result of one or more item listings for a client device to display to a user via a graphical user interface (GUI), the one or more item listings selected based, at least in part, on the data representing the second set of one or more pre-trend item characteristics.

2. The non-transitory machine-useable storage medium of claim 1, wherein the first and second set of item characteristics each include an item brand.

3. The non-transitory machine-useable storage medium of claim 1, wherein the first and second set of item characteristics each include an item type.

4. The non-transitory machine-useable storage medium of claim 1, wherein the operation of identifying the first set of one or more popular item characteristics from the electronic marketplace transaction data comprises identifying one or more item characteristics associated with a quantity of marketplace transactions increasing over a plurality of time intervals.

5. The non-transitory machine--useable storage medium of claim 4, wherein the operation of identifying the first set of one or more popular item characteristics from the electronic marketplace transaction data comprises identifying one or more item characteristics associated with a transaction revenue increasing over the plurality of time intervals.

6. The non-transitory machine-useable storage medium of claim 1, wherein the operation of identifying the one or more users is based, at least in part, on profile data of a runtime user.

7. The non-transitory machine-useable storage medium of claim 1, wherein the operation of identifying the one or more users comprises identifying the one or more users, from the electronic marketplace transaction data, associated with marketplace transactions for items having additional identified popular item characteristics during the first time interval.

8. The non-transitory machine-useable storage medium of claim 1, wherein the operations further comprise:
identifying a third set of one or more item characteristics associated with a decreasing quantity of marketplace transactions associated with the identified one or more users over a plurality of time intervals.

9. A computer implemented method comprising:
receiving a query for one or more item listings of an electronic marketplace database;
identifying a first set of one or more popular item characteristics from electronic marketplace transaction data;
identifying one or more users, from the electronic marketplace transaction data, associated with marketplace transactions for items having the first set of identified popular item characteristics during a first time interval;
identifying a second set of one or more pre-trend item characteristics, from the electronic marketplace transaction data, associated with marketplace transactions of the identified users during a second time interval more recent than the first time interval; and
generating display data representing a query result of one or more item listings for a client device to display to a user via a graphical user interface (GUI), the one or more item listings selected based, at least in part, on the data representing the second set of one or more pre-trend item characteristics.

10. The method of claim 90 wherein the first and second set item characteristics each include an item brand.

11. The method of claim 9, wherein the first and second set item characteristics each include an item type.

12. The method of claim 9, wherein identifying the first set of one or more popular item characteristics from the electronic marketplace transaction data comprises identifying one or more item characteristics associated with a quantity of marketplace transactions increasing over a plurality of time intervals.

13. A system comprising:
a transaction analysis engine to:
identify a first set of one or more popular item characteristics from electronic marketplace transaction data;
identify one or more users, from the electronic marketplace transaction data, associated with marketplace transactions for items having the first set of identified popular item characteristics during a first time interval; and
identify a second set of one or more pre-trend item characteristics, from the electronic marketplace transaction data, associated with marketplace transactions of the identified users during a second time interval more recent than the first time interval;
an item listing search engine to:
receive a query for one or more item listings of an electronic marketplace database; and
generate display data representing a query result of one or more item listings for a client device to display to a user via a graphical user interface (GUI), the one or more item listings selected based, at least in part, on the data representing the second set of one or more pre-trend item characteristics;
one or more memory devices communicatively coupled to the transaction analysis engine and the item listing search engine; and
one or more processors to execute the transaction analysis engine and the item listing search engine.

14. The system of claim 13, wherein the first and second set of item characteristics each include an item brand.

15. The system of claim 13, wherein the first and second set of item characteristics each include an item type.

16. The system c:claim 13, wherein the operation to identify the first set of one or more popular item characteristics from the electronic marketplace transaction data comprises an operation to identify one or more item characteristics associated with a quantity of marketplace transactions increasing over a plurality of time intervals.

17. The system of claim 16, wherein the operation to identify the first set of one or more popular item characteristics from the electronic marketplace transaction data further comprises an operation to identify one or more item characteristics associated with a transaction revenue increasing over the plurality of time intervals.

18. The system of claim 13, wherein the operation to identify the one or more users is based, at least in part, on profile data of a runtime user.

19. The system of claim 13, wherein the operation to identify the one or more users further comprises identifying; the one or more users, from the electronic marketplace transaction data, associated with marketplace transactions for items having additional identified popular item characteristics during the first time interval.

20. The system of claim 3, wherein the transaction analysis engine is to further:
identify a third set of one or more item characteristics associated with a decreasing quantity of marketplace transactions associated with the identified one or more users over a plurality of time intervals.
